(19) United States
(12) Patent Application Publication
(10) Pub. No.: US 2007/0231556 A1
(43) Pub. Date: Oct. 4, 2007

(54) Method for manufacturing composite membrane for polymer electrolyte fuel cell

(75) Inventors: Jung-Ki Park, Daejeon (KR); Ho-Young Jung, Daejeon (KR); Ki-Yun Cho, Daejeon (KR); Wan-Ho Seol, Daejeon (KR); Kyung-A Sung, Daejeon (KR); Wan-Keun Kim, Daejeon (KR)

Correspondence Address: STERNE, KESSLER, GOLDSTEIN & FOX P.L.L.C., 1100 NEW YORK AVENUE, N.W., WASHINGTON, DC, 20005, US

(73) Assignee: Korea Advanced Institute of Science and Technology, Daejeon (KR)

(21) Appl. No.: 11/714,902

(22) Filed: Mar. 7, 2007

(30) Foreign Application Priority Data
Mar. 7, 2006 (KR) 10-2006-0021403

(51) Int. Cl. B32B 27/32

(52) U.S. Cl. 428/220

(57) ABSTRACT

The present invention relates to a method for manufacturing a polymer electrolyte fuel cell, and more particularly to a method for manufacturing a polymer composite membrane whose dimensional stability in accordance with hydration is good and a proton conductivity is improved by introducing a fluorinated polymer with a good excellent dimensional stability to sulfonated hydrocarbon-based polymers as proton conducting materials.

### CROSS-REFERENCE TO RELATED APPLICATIONS

The present invention claims priority to Korean Patent Application No. 2006-0021403, filed on Mar. 7, 2006, which is incorporated herein by reference in its entirety.

### BACKGROUND OF THE INVENTION

1. Field of the Invention

The present invention relates, generally, to a method for manufacturing a composite membrane for a polymer electrolyte fuel cell, and more particularly, to a method for manufacturing a polymer composite membrane whose dimensional stability in accordance with hydration is excellent and proton conductivity is improved.

2. Description of the Related Art

In accordance with the rapid development of an informational communication technology recently, a portable electronic device-related technology related to cellular phones, notebook computers, personal digital assistants (PDAs), digital cameras and camcorders rapidly grows. The development of such portable electronic device-related technology is represented as the high functionalization of the portable electronic devices in order to satisfy consumers' tastes requiring for more information. However, the high functionalization of the above devices is limited in a continuous use for a long time due to a great deal of energy consumption and therefore the apparatus for providing themselves with an energy became a core technical element affecting the performance of electronic products. The above technical request became a motive force for researching and developing a fuel cell-related technology in the advanced countries including the US and Japan more briskly.

A fuel cell is an apparatus for directly transforming a chemical energy into an electric energy, of which an oxidation reaction of a fuel occurs in an anode and a reduction reaction of oxygen occurs in a cathode. The basic structure of a fuel cell consists of a catalyst-carrying anode, cathode and a membrane/electrode assembly manufactured to include an electrolyte membrane between the two electrodes. In the membrane/electrode assembly, the electrolyte layer functions as conducting protons from an anode to a cathode in accordance with the operations of the catalyst and as a separator so that a fuel is not directly mixed with oxygen. The material which is currently used as an electrolyte membrane of a polymer electrolyte fuel cell is a perfluoro polymer-based Nafion with excellent hydration stability and high proton conductivity. However, Nafion has some flaws in a practical use because of a high manufacturing cost and poor dimensional stability. Furthermore, it has disadvantages that a proton conductivity is decreased at a high temperature (80oC.) and a methanol permeability is high when it is applied to a direct methanol fuel cell. For the above reasons, researches on a new hydrocarbon-based proton conducting material capable of being used at a high temperature but having a relatively low methanol transmission are in a brisk progress in order to replace a perfluoro polymer-based Nafion. The representative examples are poly(ether ether ketone), poly(ether sulfone), polybenzimidazole etc. However, the alternative polymer electrolyte membrane having a low methanol permeability has a high water uptake at the time of hydration, which leads to decrease a dimensional stability. In addition, it has a low proton conductivity at lower degree of sulfonation therefore it was difficult to realize the good performance of a polymer electrolyte fuel cell. Therefore, a new material having improved dimensional stability and proton conductivity of the alternative electrolyte membrane is requested to be developed in order to obtain an improved cell performance.

In the meantime, as a conventional technology related to the present invention, a research on introducing a copolymer of vinylidene fluoride and hexafluoropropylene to a Nafion solution (with concentration of 5 wt %) was partially performed. (Korean Patent No. 2002-0074582) However, these researches were performed for the case that the hydrogen ionic conductive proton conducting material of a polymer electrolyte layer is Nafion. Therefore, the performance of a cell is decreased due to the decrease of a proton conductivity of Nafion at a high temperature of 80oC. In conclusion, recently a lot of researches on hydrocarbon-based materials being polymer electrolyte for driving at a high temperature in order to secure the performance at a high temperature have been performed (U.S. Pat. Nos. 6,914,084 and 6,933,068). However, as mentioned above, the hydrocarbon based-polymer electrolyte decreases a dimensional stability therefore it does not show good performance of a unit cell for a long time until now. Therefore, in order to solve the problems, the development of a material with a low methanol cross-over based on a sulfonated hydrocarbon-based polymer electrolyte membrane, a good proton conductivity at a high temperature and a dimensional stability at the time of hydration is desperately requested.

### SUMMARY OF THE INVENTION

Accordingly, the present invention has been made keeping in mind the above problems occurring in the related art, and an object of the present invention is to provide a method for manufacturing a composite membrane for a polymer electrolyte fuel cell and more particularly to a polymer composite membrane whose dimensional stability in accordance with hydration is good and a proton conductivity is improved, a material for forming the composite membrane and a method for manufacturing them.

The present invention introduces polymer materials with a good dimensional stability to sulfonated hydrocarbon-based polymer materials with low permeation rate of a fuel and good proton conductivity in a method for manufacturing a composite membrane for a polymer electrolyte fuel cell.

The concrete examples used as the sulfonated hydrocarbon-based polymer materials are one or a mixture blending at least two selected from a group consisting of polysulfone, poly(arylene ether sulfone), poly(ether ether sulfone), poly(ether sulfone), polyimide, polyimidazole, polybenzimidazole, poly(ether benzimidazole), poly(arylene ether ketone), Poly(ether ether ketone), poly(ether ketone), poly(ether ketone ketone), and polystyrene, but are not limited as long as it is a polymer material with good proton conductivity.

Herein, the sulfonation degree of a sulfonated hydrocarbon-based polymer is preferably 10 to 80%, more preferably 20 to 70% and the most preferably 30 to 60%.

The sulfonated hydrocarbon-based polymer is preferably selected from ones whose number-average molecular weight is 1,000 to 1,000,000 and a weight-average molecular weight is 10,000 to 1,000,000.

The concrete examples used as a polymer material with a good dimensional stability uses one or a mixture blending at least two selected from a group consisting of monomers of vinylidene fluoride, hexafluoropropylene, trifluoroethylene and tetrafluoroethylene, but are not limited as long as it is a polymer material with good dimensional stability. The polymer materials are preferably selected from ones whose number-average molecular weight is 1,000 to 1,000,000 and a weight-average molecular weight is 10,000 to 1,000,000.

The polymer material with a good dimensional stability introduced to the sulfonated hydrocarbon-based polymer is preferably 0.01 to 50 w% in contrast to a sulfonated hydrocarbon-based polymer, more preferably 0.1 to 20 wt % and the most preferably 1 to 10 wt %. In excess of 50 wt %, if a polymer electrolyte composite membrane has a low proton conductivity and less than 0.01 wt %, it is worried that the dimensional stability of a polymer electrolyte composite membrane is degraded.

However, they are illustrated to show a possible scope in order to perform preferred embodiments of the present invention but are not to be construed to limit the present invention.

The thickness of a polymer electrolyte composite membrane adopted in the present invention is preferably 10 to 200 μm at a non-humidified state, more preferably 10 to 100 μm, and the most preferably 1 to 50 μm.

### BRIEF DESCRIPTION OF THE DRAWINGS

FIG. 1 shows a proton conductivity of a polymer electrolyte composite membrane manufactured in accordance with the embodiments 1 to 4 and a comparative example;

FIG. 2 shows a water uptake in the polymer electrolyte composite membrane manufactured in accordance with the embodiments 1 to 4 and the comparative example;

FIG. 3 shows the dimensional stability of the polymer electrolyte composite membrane manufactured in accordance with the embodiments 1 to 4 and a comparative example; and

FIG. 4 shows a compatibility of a polymer electrolyte composite membrane manufactured in accordance with the embodiment 4 and a glass transition temperature.

### DETAILED DESCRIPTION OF EMBODIMENTS OF THE INVENTION

In the meantime, the present invention includes a fuel cell containing the above manufactured polymer electrolyte composite membrane.

A better understanding of the present invention may be obtained through the following preferred embodiments showing the more exemplified manufacturing steps, which are set forth to illustrate the contents of the present invention, but are not to be construed to limit the scope of the present invention.

### Embodiment 1

In order to sulfonate the poly(ether ether ketone), 98% of high concentrated sulfuric acid of 50 ml is put into a round bottomed flask of 100 ml and nitrogen is purged. 2 g of poly(ether ether ketone) polymer dried in vacuum for 24 hours at 100oC. is added and then stirred vigorously at the temperature of a chemical reactor of 50oC. After the sulfonation reaction for 6 to 24 hrs, the reactant is precipitated in deionized water, and then it is filtered and recovered. The recovered reactant is washed several times by the same method so that its acidity is neutral to 6 to 7 and filtered to recover the reactant, again. The recovered reactant is dried in vacuum for 24 hours at 50oC. to obtain a sulfonated poly(ether ether ketone) polymer.

The table 1 shows the sulfonation degree of a sulfonated hydrocarbon-based polymer being poly(ether ether ketone) used as a matrix of a polymer electrolyte composite membrane in accordance with a reaction time.

TABLE 1
Sulfonation degree in accordance with reaction time

Reaction time (hr)

| | 6 | 9 | 12 | 24 |
|---|---|---|---|---|
| Sulfonation degree | 50 | 60 | 70 | 90 |

After the prepared sulfonated poly(ether ether ketone) polymer is dissolved to 10 wt % in a solvent, poly(vinylidene fluoride) (PVdF) of 2.5 wt % in contrast to the sulfonated poly(ether ether ketone) polymer is introduced in order to mix the sulfonated poly(ether ether ketone) polymer and poly(vinylidene fluoride). After a homogeneous mixture is obtained, it is cast on a glass plate by a doctor blade. It is dried in an oven at 50oC. for 72 hours and immersed in a deionized water to obtain a composite membrane of a sulfonated poly(ether ether ketone) polymer and poly(vinylidene fluoride). Then, it is dried in a vacuum oven at 50oC. for 24 hours again to obtain the final composite membrane of the sulfonated poly(ether ether ketone) polymer and poly(vinylidene fluoride).

### Embodiment 2

Except that the content of poly(vinylidene fluoride) of 5 wt % in contrast to the sulfonated poly(ether ether ketone) is introduced, a composite membrane is prepared by the same method using the components and composition described in the embodiment 1.

### Embodiment 3

Except that the content of poly(vinylidene fluoride) of 10 wt % in contrast to the sulfonated poly(ether ether ketone) is introduced, a composite membrane is prepared by the same method using the components and composition described in the embodiment 1.

### Embodiment 4

Except that the content of poly(vinylidene fluoride) of 20 wt % in contrast to the sulfonated poly(ether ether ketone) is introduced, a composite membrane is prepared by the same method using the components and composition described in the embodiment 1.

### Embodiment 5

Except that a proton conducting polymer uses a sulfonated polyarylene ether sulfone instead of a sulfonated poly(ether ether ketone), a composite membrane is prepared by the same method using the components and composition described in the embodiments 1, 2, 3 and 4.

### Embodiment 6

Except that a proton conducting polymer uses a polyimide instead of a sulfonated polyarylene ether sulfone, a composite membrane is prepared by the same method using the components and composition described in the embodiment 5.

### Embodiment 7

Except that a proton conducting polymer uses polystyrene instead of a sulfonated polyarylene ether sulfone, a composite membrane is prepared by the same method using the components and composition described in the embodiment 5.

### Embodiment 8

Except that a polymer whose monomer is composed of hexafluoride propylene instead of poly(vinylidene fluoride) which is a polymer with a good dimensional stability is used, a composite membrane is prepared by the same method using the components and composition described in the embodiments 1 to 7.

### Comparative Example

The manufactured sulfonated poly(ether ether ketone) polymer is dissolved to 10 wt % in a solvent and cast on a glass plate by a doctor blade. It is dried in an oven at 50oC. for 72 hours and immersed in a deionized water to obtain a sulfonated poly(ether ether ketone) polymer membrane. Then, it is dried in a vacuum oven at 50oC. for 24 hours again to obtain the final sulfonated poly(ether ether ketone) polymer electrolyte membrane.

### Experimental Example 1

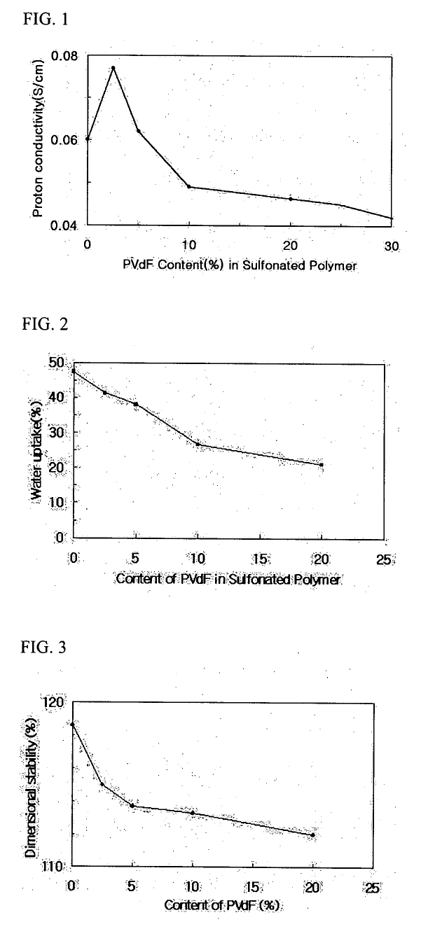

The proton conductivity of a polymer electrolyte membrane prepared in the above embodiments 1 to 4 and the comparative example is measured by an impendence spectroscopy made by Solartron Inc. and the results are shown in the graph of FIG. 1.

The condition for measuring an impedance is that a frequency is set to 1 Hz to 1 MHz.

The proton conductivity is measured by an in-plane method and all experiments are performed at the state that specimen are completely hydrated.

As shown in the experimental results of FIG. 1, it is known that in case that an infinitesimal of poly(vinylidene fluoride) is added to a sulfonated polymer, the proton conductivity of a polymer electrolyte membrane increases and then decreases as the added amount of poly(vinylidene fluoride) increases more. The reason why the proton conductivity of a polymer electrolyte composite membrane with a specified added amount can be improved is due to the existence of regions where strong hydrophilic proton conducting channels are more continuously connected. However, strong hydrophobic poly(vinylidene fluoride) is further added into the sulfonated hydrocarbon-based polymer resulting in the discontinuous connection of proton conducting channels. If the content of strong hydrophilic poly(vinylidene fluoride) increases more, the water uptake capable of greatly affecting a proton conductivity is decreased and the proton conductivity of a polymer electrolyte layer membrane is decreased due to the discontinuity of proton conducting channels.

FIG. 1 shows the numerals of a proton conductivity by dots in case that the content of poly(vinylidene fluoride) is 0 wt % (comparative example), 2.5 wt % (embodiment 1), 5 wt % (embodiment 2), 10 wt % (embodiment 3) and 20 wt % (embodiment 4), respectively and a graph obtained by connecting the numerals.

### Experimental Example 2

The water uptake of the polymer electrolyte membrane prepared in the embodiments 1 to 4 and the comparative example is measured at a ratio of the change of weights before and after hydration and the results are shown in the graph of FIG. 2.

As known from the results of FIG. 2, the water uptake in a composite membrane introducing poly(vinylidene fluoride) to a sulfonated polymer is decreased in accordance with the amount of the added poly(vinylidene fluoride). This means that the ion exchange capacity (IEC) of a composite membrane is relatively lowered in accordance with the amount of the added poly(vinylidene fluoride) from the existing ion exchange capacity (IEC) of a sulfonated polymer and the decrease of IEC of the composite membrane means that the number of a sulfonated group present inside the polymer composite membrane is decreased. Finally, the number of water molecules present in the composite membrane is also decreased by interactions with the sulfonated group.

Therefore, the water uptake is decreased in accordance with the increase of the content of poly(vinylidene fluoride) added to the polymer composite membrane.

FIG. 2 shows the numerals of a water uptake by dots in case that the content of poly(vinylidene fluoride) is 0 wt % (comparative example), 2.5 wt % (embodiment 1), 5 wt % (embodiment 2), 10 wt % (embodiment 3) and 20 wt % (embodiment 4), respectively and a graph obtained by connecting the numerals.

### Experimental Example 3

The dimensional stability of the polymer electrolyte membrane prepared in the embodiments 1 to 4 and the comparative example is measured at a ratio of the changes of weights before and after hydration and the results are shown in the graph of FIG. 3.

As known from the results in FIG. 3, the dimensional stability is obtained as the amount of poly(vinylidene fluoride) added to a sulfonated polymer increases. It is known that poly(vinylidene fluoride) with a good dimensional stability with respect to water is added to a sulfonated polymer with a high water uptake to improve the dimensional stability of a polymer electrolyte composite membrane.

FIG. 3 shows the numerals of dimensional change by dots in case that the content of poly(vinylidene fluoride) is 0 wt % (comparative example), 2.5 wt % (embodiment 1), 5 wt % (embodiment 2), 10 wt % (embodiment 3) and 20 wt % (embodiment 4), respectively and a graph obtained by connecting the numerals.

### Experimental Example 4

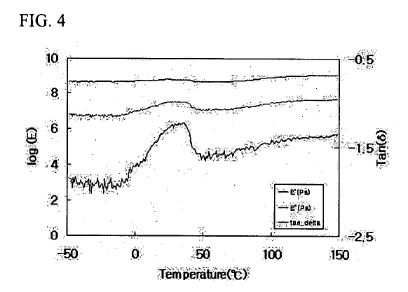

The compatibility of a polymer electrolyte membrane manufactured in the embodiment 4 is determined by measuring a glass transition temperature by dynamic mechanical analysis and the results are shown in FIG. 4.

As known from the results of FIG. 4, it is confirmed that a polymer electrolyte composite membrane adding a small amount (˜20%) of poly(vinylidene fluoride) to a sulfonated polymer is formed at 37oC. of only one glass transition temperature, and therefore, there is a compatibility of the two polymers.

The composite membrane for a polymer electrolyte fuel cell according to the present invention introduces a polymer with a good dimensional stability to a hydrocarbon-based proton conducting polymer electrolyte to improve the proton conductivity and the dimensional stability of a polymer electrolyte composite membrane.

In addition, it is fundamental that a hydrophobic polymer is introduced to a hydrocarbon-based proton conducting polymer to control the swelling degree and to decrease the permeation rate of a fuel.

What is claimed is:

1. A method for manufacturing a polymer electrolyte composite membrane characterized in that polymers with a good dimensional stability are introduced to proton conducting hydrocarbon-based polymer.

2. The method as in claim 1, wherein the proton conducting hydrocarbon-based polymer uses one or a mixture of at least two selected from a group consisting of polysulfone, poly(arylene ether sulfone), poly(ether ether sulfone), poly(ether sulfone), polyimide, polyimidazole, polybenzimidazole, polyether benzimidazole, poly(arylene ether ketone), poly(ether ether ketone), poly(ether ketone), poly(ether ketone ketone), and polystyrene.

3. The method as in claim 2, wherein the sulfonation degree of a proton conducting hydrocarbon-based polymer is 10 to 80%.

4. The method as in claim 2, wherein the proton conducting hydrocarbon-based polymer has a number-average molecular weight of 1,000 to 1,000,000 and a weight-average molecular weight of 10,000 to 1,000,000.

5. The method as in claim 1, wherein the polymer material with a good dimensional stability uses one or a mixture blending at least two selected from a group consisting of monomers of vinylidene fluoride, hexafluoropropylene or trifluoroethylene and tetrafluoroethylene.

6. The method as in claim 1, wherein the content of a polymer material with a good dimensional stability introduces 0.1 to 50 wt % in contrast to a proton conducting polymer.

7. The method as in claim 5, wherein the polymer material with a good dimensional stability has a number-average molecular weight is 1,000 to 1,000,000 and a weight-average molecular weight is 10,000 to 1,000,000.

8. The method as in claim 1, wherein the polymer material with a good dimensional stability introduced to a proton conducting hydrocarbon-based polymer is 0.01 to 50 w% in contrast to a sulfonated hydrocarbon-based polymer.

9. The method as in claim 1, wherein the thickness of a layer is 10 to 200 μm at a non-humidified state.
